(19) United States
(12) Patent Application Publication
(10) Pub. No.: US 2015/0143944 A1
(43) Pub. Date: May 28, 2015

(54) Accelerator Pedal Unit for Motor Vehicles

(71) Applicant: Conti Temic microelectronic GmbH, Nuemberg (DE)

(72) Inventors: Andreas Zell, Nuernberg (DE); Carmelo Leone, Freising (DE); Mihaly Szasz, Mures/Bahnea (RO); Norbert Silberleitner, Sibiu/Sibiu (RO); Johannes Heydenreich, Wuerzburg (DE); Nobuaki Okumoto, Togane-city (JP)

(21) Appl. No.: 14/402,207

(22) PCT Filed: May 22, 2013
(86) PCT No.: PCT/EP2013/060481

§ 371 Date: Nov. 19, 2014

(30) Foreign Application Priority Data
May 22, 2012 (DE) 10 2012 208 548.3
Sep. 4, 2012 (DE) 10 2012 215 685.2
May 21, 2013 (DE) 10 2013 209 370.5

(51) Int. Cl. G05G 5/03; B60K 26/02; G05G 1/44

(52) U.S. Cl. CPC G05G 5/03; G05G 1/44; B60K 26/021; B60K 2026/022; B60K 2026/023
USPC 74/514

(57) ABSTRACT

An accelerator pedal unit (1) for a motor vehicle includes an accelerator pedal (11) for controlling a propelling force of a motor of the motor vehicle, and a return spring. A position change of the accelerator pedal (11) from its starting position caused by an actuating force against a restoring force exerted by the return spring results in an increase of the propelling force of the motor, and the restoring force of the return spring returns the accelerator pedal (11) toward its starting position when the actuating force subsides. A friction device (100, 200, 300, 400, 500, 600) generates a friction force that acts in addition to the restoring force. Alternatively, an electromechanical main actuator (18) produces an additional restoring force (F_{Zusatz}) that can be variably controlled using a control unit (12).

This invention relates to an accelerator pedal unit for motor vehicles comprising an accelerator pedal for controlling a propelling force of a motor of a motor vehicle, a return spring, wherein a position change of the accelerator pedal from its starting position caused by a respective actuating force against a restoring force exerted by the return spring results in an increase of the propelling force of the motor, and the restoring force of the return spring returns the accelerator pedal to its starting position when the actuating force subsides.

Modern motor vehicles generally have the problem that the driver is provided with much information from said motor vehicle. This over-stimulation of the driver by acoustic and optical signals creates a distraction from traffic. As a result, the driver tends to miss or ignore signals or can no longer assign them to their cause. An accelerator pedal of the type mentioned above avoids all the disadvantages of optical and acoustic systems: It is a suitable human-machine interface for longitudinal dynamic functions (distance information, speed limit and control) and for displaying hazard statements.

DE 32 32 160 A1 therefore discloses a device in which the restoring force of the accelerator pedal can be changed and provides haptic feedback to the driver. The restoring force of the accelerator pedal is automatically adjusted across the entire pedal travel as a function of characteristics that reflect the motor torque and motor speed. In the known device, a hydraulic actuator is provided that is connected to the accelerator pedal via a spring. Such actuators are comparatively complex because they have to be controllable.

Previously known direct drives show a very good haptic behavior on the pedal and have steep, pronounced force curves with very fast response times. The disadvantage is that the system heats up fast during static operation due to the requested continuous force, which leads to a significant limitation in availability. Alternatives are high-transmission actuators, which have haptic and acoustic disadvantages.

The object is to reduce the power loss of an electromechanical actuator for an accelerator pedal unit of the type mentioned above such that its greatest possible thermal availability is achieved.

This object is achieved by an accelerator pedal unit of the type mentioned above that comprises a friction device for generating a friction force that acts in addition to the restoring force.

According to a second aspect of this invention, this object is further achieved by an accelerator pedal unit of the type mentioned above that comprises a main electromechanical actuator for generating additional restoring force that is variably controllable using a control unit, and a friction device for generating a friction force that acts in addition to the restoring force.

The invention is based on the rationale to generate the restoring force using an additional friction device that can be operated without continuous power supply or to support the main actuator and in this way reduce the electrical load of the main actuator. Under certain defined conditions, the system can maintain the force using significantly less power by inserting a mechanical device or said friction device. The thermal stress of the main actuator caused by the electrical load is drastically reduced in this way. The power consumption of the accelerator pedal unit also drops.

The friction device can be connected to and disconnected from the operation of the accelerator pedal unit. The friction device is designed such that it engages with the flux of force of the accelerator pedal under predetermined or defined conditions or is excluded from it and does not apply any force. The accelerator pedal unit can therefore still be operated, even if the friction device fails.

The friction force is a desirable and defined friction force that is generated using the friction surfaces provided. This excludes such undesirable friction forces that inevitably occur in mechanical constructions. Advantageously, the friction device is designed or configured such that a major portion of the friction force acts in the same direction as the restoring force of the main actuator. It is preferred that the entire friction force acts in the direction of the restoring force of the main actuator.

In a cost-efficient embodiment, the accelerator pedal unit according to the invention may be operated without a main actuator. It is preferred to use a main actuator as mentioned in the second aspect of the invention to produce an improved haptic sensation at the accelerator pedal.

The accelerator pedal unit according to the invention is advantageously developed further in that the friction device comprises a conical engaging body and a receiving body with a conical recess for receiving the engaging body. Engaging body and receiving body can be used as particularly simple mechanical means to switch the friction device on or off. Thanks to the conical shape of the engaging body and the matching conical recess of the receiving body, a contact force gradually builds up between these two parts as soon as the engaging body is moved into the recess of the receiving body. This contact force can be used to generate the friction force.

The accelerator pedal unit according to the invention is advantageously developed further in that the engaging body and the receiving body are aligned coaxially.

The accelerator pedal unit according to the invention is advantageously developed further in that the engaging body and/or the receiving body comprise a friction surface, wherein the friction force can be generated using said friction surface as soon as the engaging body engages in the recess of the receiving body.

The accelerator pedal unit according to the invention is advantageously developed further in that the engaging body is formed in multiple parts.

Particularly preferred is an embodiment of the accelerator pedal unit according to the invention that comprises a bistable auxiliary actuator for moving the receiving body or the engaging body in the direction of their respective longitudinal axis. The bistable auxiliary actuator can be used to keep the receiving body or the engaging body in their respective position without using electricity, and, if required, to move them into the desired positions. The bistable auxiliary actuator is characterized in that it can move a part that is coupled with the auxiliary actuator into multiple positions by means of power supply. The movable part can be kept in a position without electricity, for example, by using a permanent magnet.

The accelerator pedal unit according to the invention is advantageously developed further in that the receiving body can be moved and kept between two positions using the auxiliary actuator.

The accelerator pedal unit according to the invention is advantageously developed further in that the main or auxiliary actuator comprises a plunger element, wherein the engaging body can be coupled with one of the plunger elements by means of the receiving body.

The accelerator pedal unit according to the invention is advantageously developed further in that the auxiliary actuator is spring-mounted in the direction of its longitudinal axis using a spring element. This embodiment allows a particularly simple mechanical design of the accelerator pedal unit and can be implemented cost-efficiently.

The accelerator pedal unit according to the invention is advantageously developed further in that the main and auxiliary actuators each comprise a plunger element, wherein the plunger element of the auxiliary actuator is arranged inside the plunger element of the main actuator and the plunger elements are coupled to one another.

The accelerator pedal unit according to the invention is advantageously developed further in that the plunger elements are positively connected.

The accelerator pedal unit according to the invention is advantageously developed further in that the plunger element of the auxiliary actuator is non-positively connected to the engaging body.

The accelerator pedal unit according to the invention is advantageously developed further in that the plunger element of the auxiliary actuator is spring-mounted along its longitudinal axis relative to the main actuator.

The accelerator pedal unit according to the invention is advantageously developed further in that the main and the auxiliary actuators are arranged inside a housing.

The object is further achieved by a third aspect of the invention comprising a vehicle with an accelerator pedal unit according to any one of the embodiments mentioned above.

Other preferred embodiments can be derived from the following description of an embodiment with reference to the figures.

Wherein:

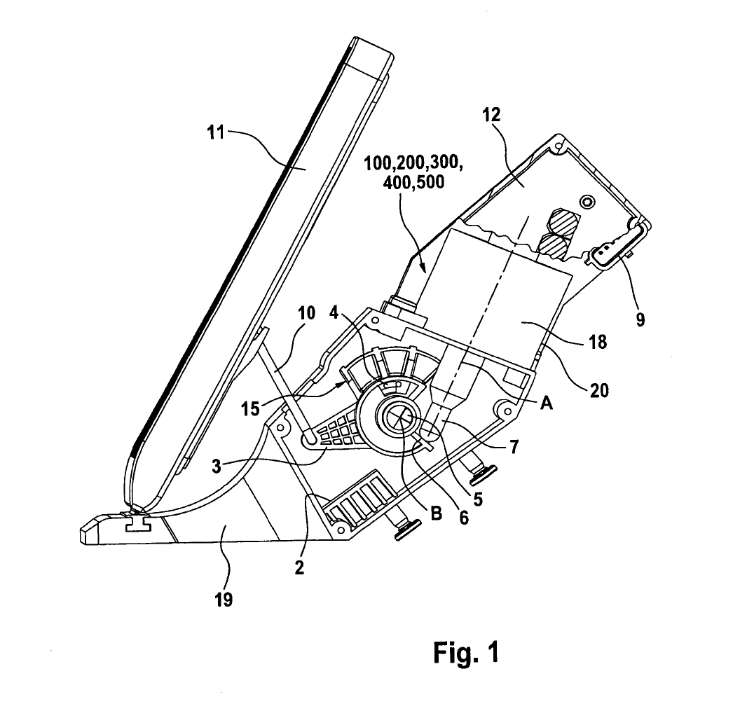

FIG. 1 is a partially sectional side view of an accelerator pedal unit according to the invention;

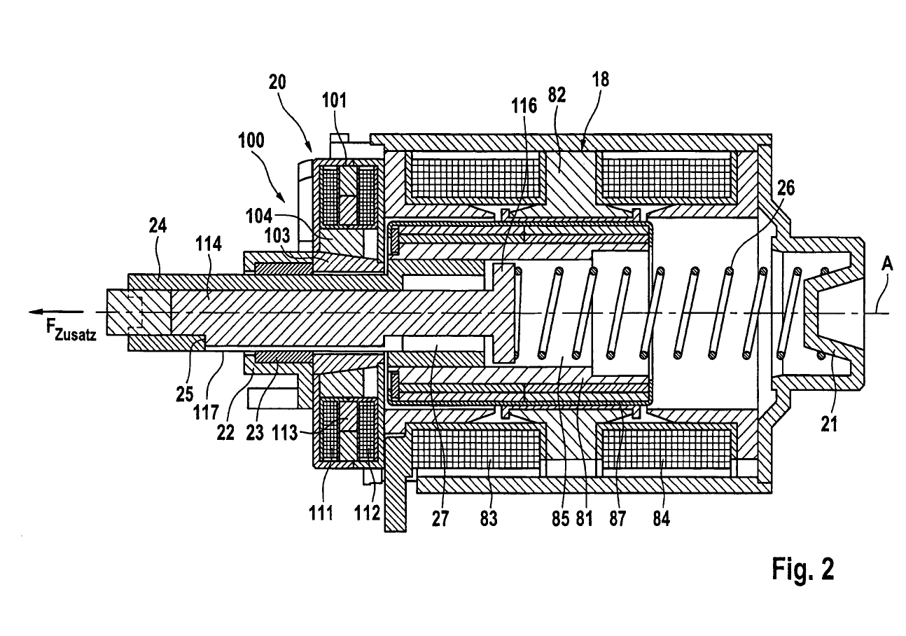

FIG. 2 is a sectional side view of a the actuator of an accelerator pedal unit according to the invention according to a first embodiment;

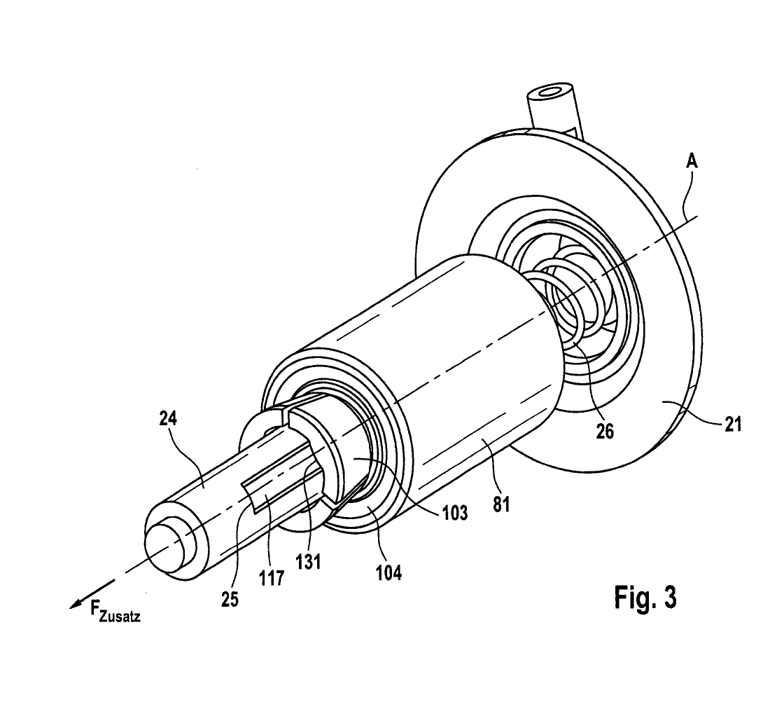

FIG. 3 is a perspective view of parts of the actuator of the first embodiment;

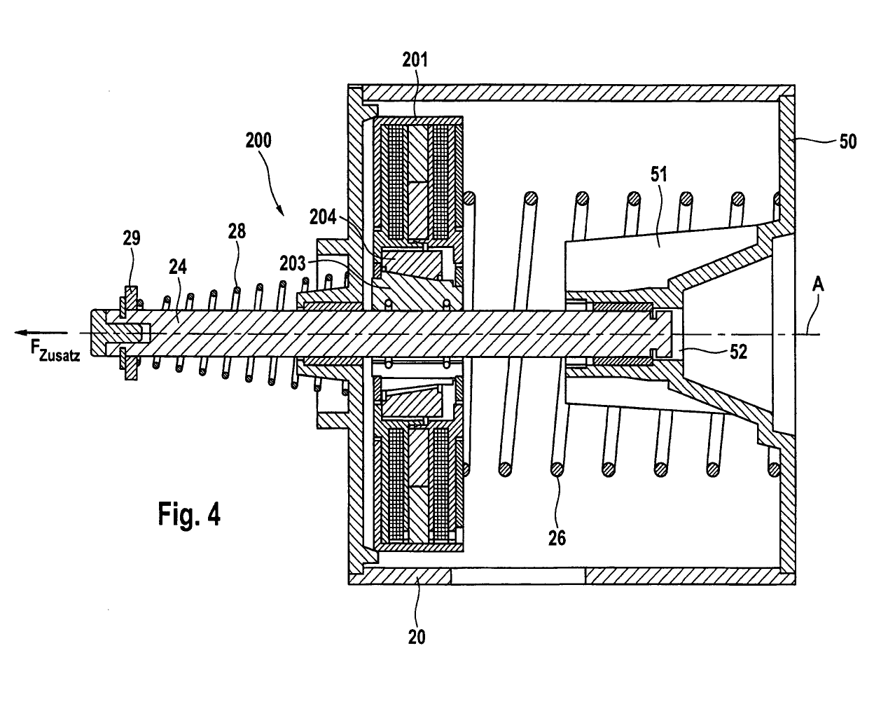

FIG. 4 is a sectional side view of the actuator of the accelerator pedal unit of the invention according to a second embodiment;

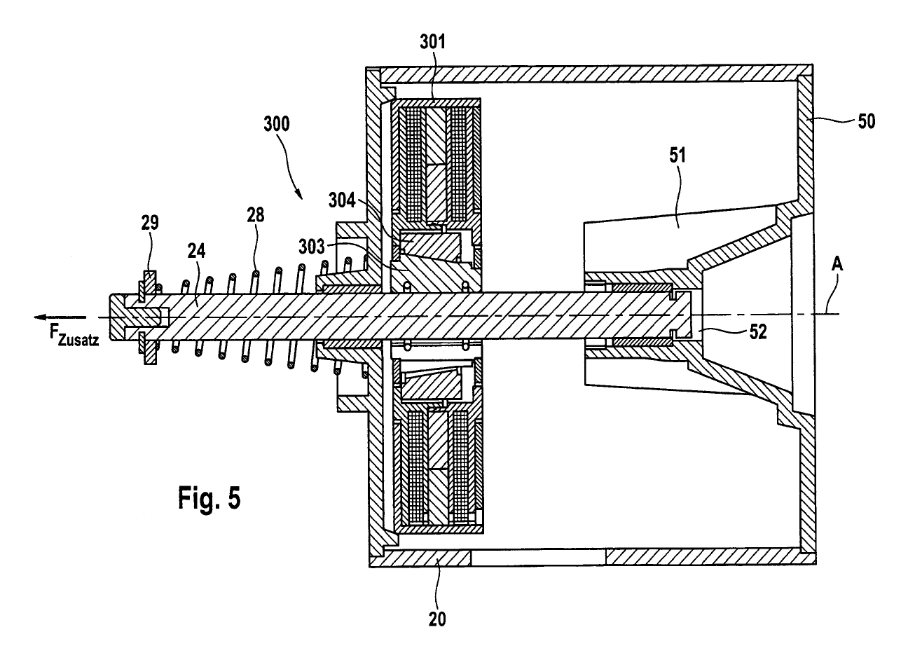

FIG. 5 is a sectional side view of the actuator of the accelerator pedal unit of the invention according to a third embodiment;

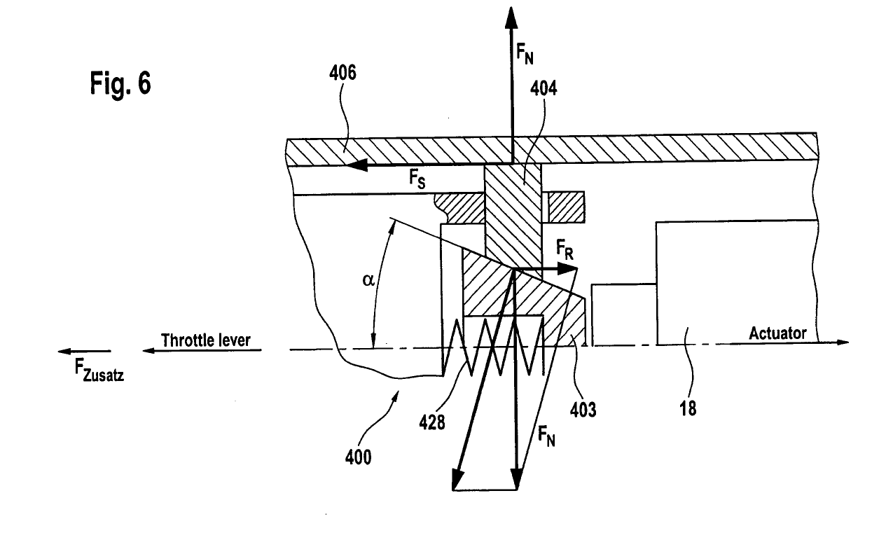

FIG. 6 is a side view of the friction device according to a fourth embodiment;

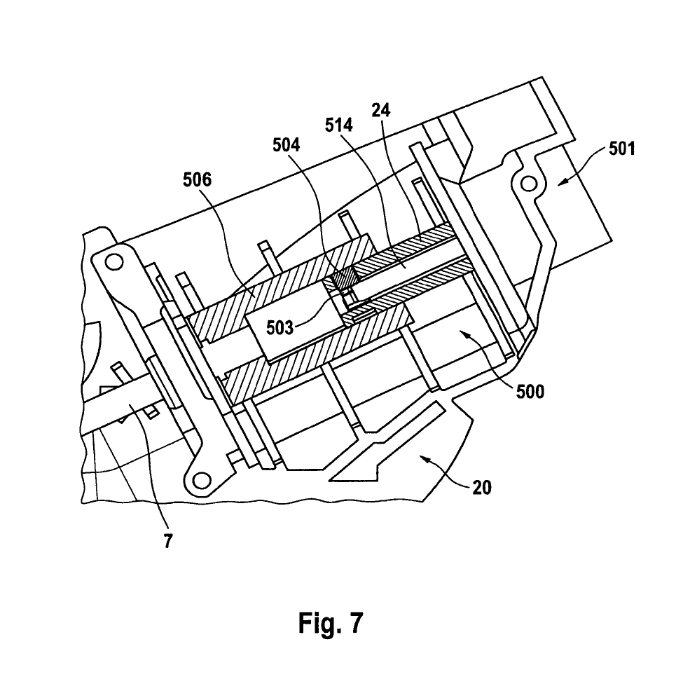

FIG. 7 is a sectional side view of the actuator of an accelerator pedal unit of the invention according to a fifth embodiment;

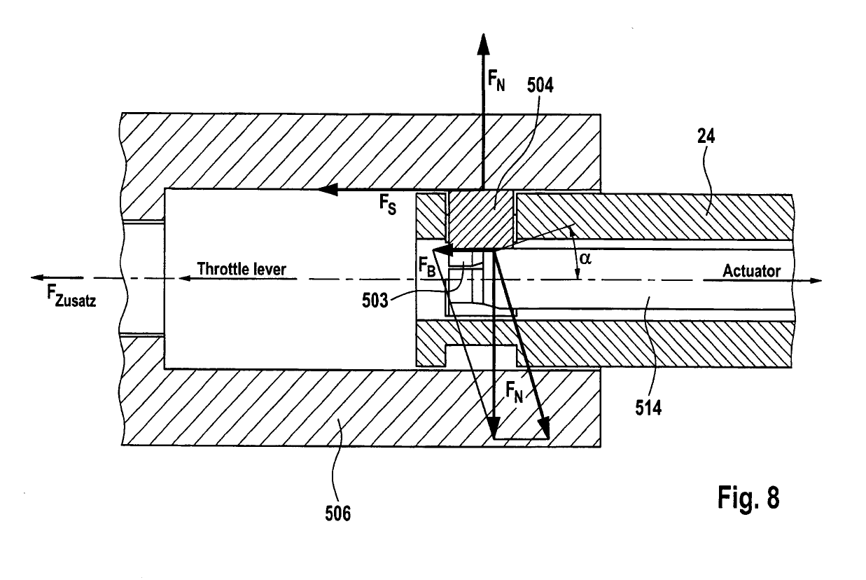

FIG. 8 is a detailed sectional view of the actuator of an accelerator pedal unit of the invention according to the fifth embodiment;

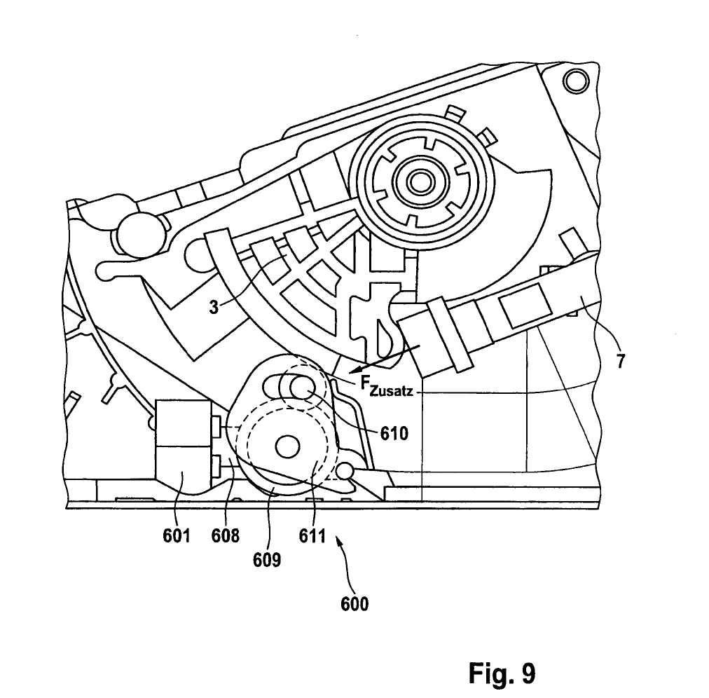

FIG. 9 is a side view of a partial region of the accelerator pedal unit of the invention according to a sixth embodiment.

The initial state is shown in FIG. 1. FIG. 1 shows an accelerator pedal unit 1 of a motor vehicle comprising an accelerator pedal 11 for controlling the propelling force of a motor of a motor vehicle. A change in position of the accelerator pedal 11 relative to its starting position caused by a respective actuating force against a restoring force exerted by a return spring not shown here results in an increase of the propelling force of the motor. It is unimportant in this respect whether the drive motor of the motor vehicle is an internal combustion engine or multiple electric motors, or a combination thereof. When the actuating force subsides, the restoring force exerted by the return spring moves the accelerator pedal 11 back in the direction of its starting position. An electromechanical main actuator 18 generates an additional restoring force that can be variably controlled using a control unit 12. The accelerator pedal 1 further comprises a friction device 100, 200, 300, 400, 500, 600 (shown in FIGS. 2 to 9) for generating a friction force Fₛ that acts in addition to the restoring force. The accelerator pedal unit shown in FIG. 1 is a so-called standing accelerator pedal unit: the pedal plate 11 is pivotably installed in a support device 19, which is typically mounted on the floor in the footwell of a motor vehicle. The invention is not limited to this type of accelerator pedals.

The general operating principle of the accelerator pedal unit is described below.

If the pedal plate 11 is depressed, it turns about its axis of rotation. The pedal plate 11 actuates an transmission element 10, which itself is connected to a cam disk 3. The cam disk 3 is rotated about an axis B due to the force transmitted from the pedal plate 11 via the transmission element 10 to the cam disk 3. An electromechanical actuator designed as a lifting magnet 18 in this embodiment also acts on the cam disk 3: the plunger element or magnetic plunger 7 of the lifting magnet 18 is in close contact with an attachment face 6 of the cam disk 3 and can be moved along an axis A by the lifting magnet 18.

Since the magnetic plunger 7 only touches the attachment face 6, the lifting magnet 18 can only produce a force acting in the direction of returning the pedal plate 11. The lifting magnet 18 cannot generate a greater depression of the pedal plate 11 than the depression set by the driver's foot pressure. Its additional restoring force F_{Zusatz} only acts in the return direction.

Depressing the pedal plate 11 causes the cam disk 3 together with a magnet 5 to rotate about the axis B. A sensor not shown here that is connected to a control unit determines the position of the pedal plate 11 using the magnet 5 that moves along with the cam disk 3.

If an additional restoring force F_{Zusatz} is to be generated, another control unit 12 sends an electric signal to the lifting magnet 18. The lifting magnet 18 is a non-commutated direct drive with a limited lift that comprises the magnetic plunger 7 and a stationary coil for providing the Lorentz force. The lifting magnet 18 can thus be triggered using electric signals from the control unit 12, such that the driver can feel the additional restoring force F_{Zusatz} as a vibration or force pulse at the pedal plate 11. Depending on the numerous functions of the type of additional restoring force F_{Zusatz} either the size of the additional restoring force F_{Zusatz} can be adjusted or the maximum travel of the pedal plate 11 can be limited.

As can be seen in FIG. 1, the maximum travel of the pedal plate 11 is reached when the cam disk 3 comes to rest against a stop 2. The travel of the pedal plate 11 can be limited by a correspondingly large restoring force F_{Zusatz} of the lifting magnet 18 even before this maximum travel is reached. The driver will then feel a force threshold at the pedal plate 11 that can only be overcome if more force is applied. This limits the maximum travel of the pedal plate 11. This function can be used to prompt the driver to adopt an energy-saving driving style.

The additional restoring force F_{Zusatz} gives haptic information to the driver. If the additional restoring force F_{Zusatz} is increased at an inefficient motor speed and the pedal resistance becomes stronger, the driver can be prompted to operate the motor vehicle in an efficient and fuel-saving manner. Alternatively, the maximum travel of the pedal plate 11 can be limited. Other haptic information that can be provided to the driver includes safety-critical information such as an insufficient distance to a preceding vehicle.

Embodiments of the accelerator pedal unit 1 including various embodiments of the friction devices 100, 200, 300, 400, 500, 600 are described in greater detail below.

FIG. 2 shows a second embodiment of the accelerator pedal unit according to the invention having a friction device 100. This embodiment is more expensive compared to the second and third embodiments, but it provides particularly sensitive and variable control of the haptic feedback.

The main actuator 18 and the friction device 100 with a bistable auxiliary actuator 101 are arranged in a housing 20.

The housing 20 of the main actuator is substantially cylindrical. The main actuator 18 and auxiliary actuator 101 of the friction device 100 are adjacently placed between the two end faces of the housing. A stop 21 for a spring element 126 is provided on a rear end face. A section 22 for receiving a bearing 23 to support the first and second plunger elements 24, 114 is formed onto a front end face. The first plunger element 24 in the following examples replaces the magnetic plunger 7 from FIG. 1.

The main actuator 18 is designed as the main actuator and comprises a movable core 81 with a permanent magnet system 87 and a guide cylinder 82 in which one or more coils 83, 84 are housed depending on the embodiment. Other direct linear electric drives can be used as main actuator 18.

The main and auxiliary actuators 18, 101 each comprise a plunger element 24, 114, wherein the second plunger element 114 of the auxiliary actuators 101 is located inside the first plunger element 24 of the main actuator 18 and the plunger elements 24, 114 are coupled to one another. It is preferred that the plunger elements 24, 114 are positively joined. The core 81 comprises a passage 185 in which the plunger elements 24, 114 are arranged sectionwise.

The first plunger element 24 is coupled to the core 81 and is moved along with the movement of the core 81 in the direction of the axis A. The first plunger element 24 comprises a stop 25 or multiple contact surfaces (see FIG. 3) via which it is positively joined with the second plunger element 114 in the direction of the restoring force F_{Zusatz}. As is shown in FIG. 3, the second plunger element 114 comprises multiple key-like projections 117 which protrude into the corresponding recesses 27 in the wall of the first plunger element 24. The recesses 27 are designed such that the second plunger element 114 can move freely in axial direction along the axis A in the direction opposite to the restoring force F_{Zusatz}. Only a spring element 26 that touches a contact surface 116 of the second plunger element 114 presses the second plunger element 114 in the direction of the restoring force F_{Zusatz} against the stop 25 on the first plunger element 24.

In a state in which the friction device 100 is switched off or deactivated, the main actuator 18 acts as follows to apply the restoring force F_{Zusatz} to the accelerator pedal 11.

Power is supplied to the coils 183, 184 to generate the restoring force F_{Zusatz}. As a result, the core 181 and with it the first plunger element 24 are moved in the direction of the restoring force F_{Zusatz}. The first plunger element 24 then presses against the contact surface 6 of the cam disk 3 such that the restoring force F_{Zusatz} acts on the accelerator pedal 11. The second plunger element 114 follows the axial movement of the first plunger element 24 along the axis A due to the spring force applied by the spring element 26. The spring force acts in addition to the restoring force F_{Zusatz}.

If the actuating force applied by the driver to the accelerator pedal 11 is greater than the restoring force F_{Zusatz}, the first plunger element 114 moves in the opposite direction of the restoring force F_{Zusatz}. In this case, the first and second plunger elements 24, 114 come into contact at the stop 25 such that the second plunger element 114 is moved along with the first plunger element 24. In this case the spring force exerted by the spring element 26 also acts regardless of power being supplied to the main actuator or not. In addition to the spring force, a friction force that acts in addition to the restoring force can be generated by switching on or activating the friction device.

The friction device 100 comprises the bistable auxiliary actuator 101 to move a receiving body 104 in the direction of its longitudinal axis, which coincides with the longitudinal axis A of the main actuator 18. The auxiliary actuator 101 comprises two coils 111, 112 to which power can be supplied. A bistable auxiliary actuator with one coil is also conceivable. The receiving body 102 can be moved along the axis A by supplying power to one of the coils 111, 112. A permanent magnet 113 for holding the receiving body in a predetermined position as soon as the power supply is switched off is located between the coils 111, 112. The friction device 100 is in its switched on state in the position of the receiving body shown in FIG. 2.

To generate the friction force, the friction device 100 comprises a conical engaging body 103 and the receiving body 102 with a conical recess 140 to receive the engaging body 103. The engaging body 103 and/or the receiving body comprise a contact surface 131, and the friction force can be generated using said contact surface 131 as soon as the engaging body 103 penetrates into the recess of the receiving body 104. In this embodiment, the contact surfaces 131 are formed on the engaging body 103.

As can be seen in FIG. 3, the contact surfaces 131 are small bulge-type projections 131 which allow exclusive contact with the second plunger element 114. This effectively prevents a frictional connection between the engaging body 103 and the first plunger element 124 to prevent a braking effect of the main actuator 18. Advantageously, the engaging body 103 is designed having multiple parts.

The engaging body 103 and the receiving body 104 are coaxially aligned, and the receiving body 104 can be moved in axial direction in this embodiment. To switch on the friction device 100, the auxiliary actuator 101 is used to move the receiving body 104 in axial direction such that the diameter of the conical recess 140 becomes smaller and the receiving body 104 and the engaging body 103 come into contact. The contact generates a normal force that presses the engaging body 103 onto the second plunger element 114. This produces a friction force at the second plunger element 114, which acts in the direction of the restoring force F_{Zusatz}.

If the receiving body 104 is moved in the opposite direction of the restoring force using the auxiliary actuator 101, the diameter of the recess 140 becomes bigger, and the receiving body 104 and the engaging body 103 do not come into contact. In this state, the parts of the engaging body 103 spread radially outwards, such that the contact surfaces no longer touch the second plunger element 114 with their projections 131. The three parts of the engaging body are thus no longer moved along in the axial direction even if the second plunger element 114 moves. It is conceivable that the amount of the friction force can be varied. This can be achieved by designing the engaging body 103 and/or the receiving body 104 such that the contact force or normal force between the engaging body 103 and the receiving body 104 varies in size depending on the position of one of the two components. In addition, it is conceivable to design the engaging body 103 and/or receiving body 104 such that a normal force acting on the engaging body is always maintained. This can be determined, for example, by the angle of gradient of the conical shape.

The advantage of this embodiment includes that the spring force and the friction force represent two additional sources of force for generating the restoring force, which can be combined to produce a multitude of haptic feedback messages. Various force signals can be generated that produce a ticking, vibrating sensation or the like on the accelerator pedal. In addition, this embodiment allows the generation of particularly excellent stepless haptic feedback.

FIGS. 4 and 5 show more cost-effective and simpler embodiments of the accelerator pedal unit according to the invention.

FIG. 4 shows an embodiment characterized in that a spring force and/or friction force can be activated in addition to the restoring force using the friction device.

The friction device 200 comprises a bistable auxiliary actuator 201. The auxiliary actuator 201 is in this case identical with the auxiliary actuator 101 of the first embodiment. The auxiliary actuator 201 is spring-mounted in the direction of its longitudinal axis using the first spring element 26. The spring element 26 is arranged between the auxiliary actuator 201 and a spring retainer plate 50.

The spring conductor plate 50 comprises a centering projection 51 to keep the spring element 26 in its planned position. The centering projection 51 comprises a passage 52 through which the plunger element 24 of the main actuator 18 can pass. This ensures axial guidance of the plunger element 24.

A second spring element 28 is provided outside the housing 20 between the outer end face of the housing 20 and a stop 29 and exerts a restoring force on the accelerator pedal 11 as soon as the plunger element 24 is moved in the opposite direction of the restoring force. In addition, the spring force of the first spring element can be activated using the friction device 200.

The receiving body 204 can be moved into a switched-on position using the auxiliary actuator 201, as shown in FIG. 4, to establish contact between the engaging body 203 and the receiving body 204. As soon as the plunger element 214 is moved in the opposite direction of the restoring force, the auxiliary actuator 201 moves along with the plunger element 24 due to the frictional connection between the engaging body 203 and the plunger element 24. The spring force of the spring element 26 counteracts that movement and at the same time acts as an additional restoring force. The frictional connection between the engaging body 203 and the plunger element 24 can be designed such that a friction-involving movement of the plunger element 24 relative to the engaging body 203 is possible.

Alternatively, it is conceivable that the plunger element 24 is additionally driven by a main actuator. The spring element 226 would in this case be arranged between the bistable auxiliary actuator 201 and the main actuator. The auxiliary actuator 201 could still be moved axially in the opposite direction of the restoring force.

FIG. 5 shows an embodiment which differs from the one of FIG. 4 in that the bistable auxiliary actuator 301 is not supported using a spring element. Instead, only one spring element 28 is provided between the second end face and the stop 329. An additional restoring force can be produced using the friction device by positively or non-positively connecting the auxiliary actuator to the housing 20. The auxiliary actuator may for example be screwed onto the end face of the housing 20. It is also conceivable to use a locking bolt that engages in the housing wall 20. It is further conceivable to use the radial outer face of the auxiliary actuator a contact surface.

Another design alternative of the friction force of the friction device is to design the non-positive connection between the engaging body 303 and the plunger element 24 such that the plunger element 24 can be moved axially involving friction.

In this embodiment, the spring element 328 is used to apply restoring force. An additional restoring force is generated using the friction force of the friction device 300 when the engaging body 303 engages in the receiving body 304 and a non-positive connection between the engaging body 303 and the plunger element 24 is achieved. In this case, the restoring force is composed of the spring force of the spring element 328 and the friction force and/or retention force of the friction device 300.

Like the second embodiment, this third embodiment can be supplemented using a main actuator such that an additional restoring force is transmitted via the plunger element 324 to the accelerator pedal 11.

FIG. 6 shows another fourth embodiment in which the friction device 400 comprises a conical engaging body 403, a receiving body 404 with a recess for receiving the engaging body 403, wherein the engaging body and the receiving body 403, 404 are guided in a guide sleeve 406.

The receiving body 404 comprises a contact surface that interacts with the guide sleeve 406. When the accelerator pedal 11 is depressed, a force is transmitted onto the engaging body 403 via the stop 6 of the cam disk 3. The spring element 428 is inserted between the cam disk 3 and the engaging body 403. The actuating force and the movement of the cam disk 3 cause the engaging body 403 to be engaged with the receiving body 404, which causes friction between the receiving body 404 and the guide sleeve 406 that acts as additional restoring force F_{Zusatz}.

FIGS. 7 and 8 show a fifth embodiment with a friction device 500 comprising a receiving body 504, a plunger element 514 with a conical engagement section 503 and a bistable auxiliary actuator 501. The second plunger element 514 of the bistable auxiliary actuator is arranged coaxially with the first plunger element 24. The second plunger element 514 is located in a guide sleeve 506. It also comprises a recess, through which the receiving body 504 can be inserted, in order to establish a non-positive force-transmitting connection to the guide sleeve 504. The receiving body 504 is in this way positively connected with the first plunger element 524. The conical engagement section 503 of the bistable auxiliary actuator will engage with the receiving body 504 when the auxiliary actuator moves the second plunger element 514 into the respective engaging position as shown in FIG. 8. In this position, a friction force Fₛ that acts as an additional restoring force is generated on the inner wall of the guide sleeve 506 using the normal force F_{N} between the receiving body 504 and the engaging body 503. The plunger elements 24, 514 interact with the magnetic plunger 7 to produce a flux of force to the accelerator pedal 11. It is preferred that the auxiliary actuator 501 can be mechanically blocked in the direction opposite to the restoring force.

FIG. 9 shows a sixth embodiment of the accelerator pedal unit according to the invention in which the friction device 600 is designed as a gear mechanism for producing an additional auxiliary restoring force.

The gear mechanism 600 is positively or non-positively joined with the cam disk 3. For example by means of a gearing. It is preferred that the friction element 608 in its retracted state is in contact with a friction wheel 609, wherein the friction wheel 608 is mechanically coupled with the cam disk 3. Alternatively, it is conceivable that the friction wheel 609 is coupled to the cam disk 3 by means of a gear wheel 610.

The friction element 600 can preferably be retracted and extended. According to this embodiment, the friction element 608 can be retracted and extended using a bistable auxiliary actuator 601. Alternatively, the friction element 608 can be retracted using a spring element.

The friction element 608 can preferably be extended when the accelerator pedal 11 is depressed and retracted when the accelerator pedal is moved back into its starting position.

Alternatively, the gear mechanism 600 comprises a slot bearing 611 with which the gear mechanism can be coupled to the cam disk 3. The gear wheel 610 is preferably coupled with the slot bearing 611. In the activated state of the accelerator pedal 3, the gear wheel 610 interacts with the slot bearing 611 to move the gear mechanism such that the friction element 608 and the friction wheel 609 come into contact. The gear wheel 610 and the slot bearing 611 disengage when the accelerator pedal is moved back into its starting position, so that the gear mechanism 600 is moved such that the contact between the friction wheel 609 and the friction element is discontinued.

1-15. (canceled)

16. An accelerator pedal unit for a motor vehicle, comprising:
an accelerator pedal configured and arranged to control a propelling force of a motor of the motor vehicle,
a return spring, wherein a position change of the accelerator pedal relative to a starting position thereof caused by an actuating force against a restoring force exerted by the return spring results in an increase of the propelling force of the motor, and the restoring force of the return spring returns the accelerator pedal in a direction toward the starting position thereof when the actuating force subsides,
a friction device configured and arranged to generate a friction force that acts in addition to the restoring force, and
a bistable auxiliary actuator,
wherein the friction device comprises an engaging body and a receiving body that has a recess configured and arranged to receive the engaging body,
wherein the engaging body and/or the receiving body comprise a friction surface that can generate the friction force as soon as the engaging body engages into the recess of the receiving body, and
wherein the bistable auxiliary actuator can move and hold the receiving body or the engaging body between two positions in a direction of a longitudinal axis of the receiving body or the engaging body.

17. The accelerator pedal unit according to claim 16, wherein the friction device is switched on to be active in one position, and switched off to be deactivated in another position.

18. The accelerator pedal unit according to claim 16, further comprising a control unit, and an electromechanical main actuator configured and arranged to generate an additional restoring force that can be variably controlled by the control unit.

19. The accelerator pedal unit according to claim 16, wherein the engaging body has a conical shape, and the recess of the receiving body has a corresponding conical recess shape adapted to receive the engaging body.

20. The accelerator pedal unit according to claim 16, wherein the engaging body and the receiving body are aligned coaxially with one another.

21. The accelerator pedal unit according to claim 16, wherein the engaging body is constructed of multiple parts.

22. The accelerator pedal unit according to claim 18, wherein the main actuator and/or the auxiliary actuator comprises a plunger element, wherein the engaging body can be non-positively coupled in a force-coupled or frictional manner to the plunger element by the receiving body.

23. The accelerator pedal unit according to claim 16, further comprising a spring element, wherein the auxiliary actuator is spring-mounted in a direction of its longitudinal axis by the spring element.

24. The accelerator pedal unit according to claim 18, wherein the main actuator and the auxiliary actuator each respectively comprise a plunger element, wherein the plunger element of the auxiliary actuator is arranged inside the plunger element of the main actuator, and the plunger elements are coupled to one another.

25. The accelerator pedal unit according to claim 24, wherein the plunger elements are positively coupled with one another in a form-fitting or form-locking manner.

26. The accelerator pedal unit according to claim 24, wherein the plunger element of the auxiliary actuator is non-positively coupled in a force-coupled or frictional manner with the engaging body.

27. The accelerator pedal unit according to claim 24, wherein the plunger element of the auxiliary actuator is spring-mounted along its longitudinal axis to the main actuator.

28. The accelerator pedal unit according to claim 24, further comprising a housing, wherein the main actuator and the auxiliary actuator are arranged inside the housing.

29. The accelerator pedal unit according to claim 16, wherein the bistable auxiliary actuator comprises at least one coil which is effective to move the receiving body when power is supplied to the coil, and a permanent magnet configured and arranged to hold the receiving body in its position when power to the coil is switched off.
